(19) United States
(12) Patent Application Publication
(10) Pub. No.: US 2021/0378057 A1
(43) Pub. Date: Dec. 2, 2021

(54) PTC HEATING MODULE AND METHOD FOR CONTROLLING THE PTC HEATING MODULE

(71) Applicant: Mahle International GmbH, Stuttgart (DE)

(72) Inventors: Simon Dangelmaier, Stuttgart (DE); Marcel Huelss, Stuttgart (DE); Falk Viehrig, Stuttgart (DE); Robin Wanke, Stuttgart (DE); Denis Wiedmann, Fellbach (DE)

(21) Appl. No.: 17/330,626

(22) Filed: May 26, 2021

(30) Foreign Application Priority Data
May 26, 2020 (DE) 102020206546.2

(51) Int. Cl. H05B 1/02; H05B 3/03

(52) U.S. Cl. CPC H05B 1/0236; H05B 3/03; H05B 2203/016; H05B 2203/007; H05B 2203/02

(57) ABSTRACT

A PTC heating module for a battery-operated motor vehicle may include a first and a second electrode, and a plurality of PTC elements. The first and second electrodes may be configured to be electrically conductive. The plurality of PTC elements may be arranged between the first and second electrodes and may be spaced apart from one another in a longitudinal direction of the PTC heating module. The first and second electrodes may be connected to the plurality of PTC elements. At least one of the first and second electrodes may be subdivided into at least two electrode tracks. The at least two electrode tracks may be electrically isolated from one another. Each of the at least two electrode tracks may be connected to the plurality of PTC elements.

### CROSS-REFERENCE TO RELATED APPLICATION

This application claims priority to German Application No. DE 10 2020 206 546.2 filed on May 26, 2020, the contents of which are hereby incorporated by reference in its entirety.

### TECHNICAL FIELD

The invention relates to a PTC heating module for a battery-operated motor vehicle according to the preamble of Claim 1 and to a method for controlling the PTC heating module.

### BACKGROUND

Today, PTC heating modules (PTC: Positive Temperature Coefficient) in battery-operated motor vehicles are today operated not in a 12V-electrical system of the motor vehicle but at the voltage level of the traction battery of 400V—the aim is 800V. When heating up the PTC heating module a voltage is applied to its PTC elements. During the heating of the PTC element its resistance is initially reduced to a minimum, which corresponds to a so-called NTC range (NTC: Negative Temperature Coefficient) of the PTC element. The resistance of the PTC element increases only thereafter and the voltage is curtailed, which corresponds to a so-called PTC range of the PTC element.

The transition between the NTC range and the PTC range is the turnover point which is passed through whenever the PTC heating module is switched on. The maximum current developing at the minimum resistance of the PTC elements loads further electronic or electrical components—such as for example conductor tracks, circuit boards, transistors, connectors etc—and is to be taken into account when designing these components. In particular during the initial heating, the pulse width modulation of the PTC heating module can lead to major voltage and current peaks, which are caused through capacitances and inductances in the PTC heating module. When a maximum permissible loading of the further components is exceeded, this can result in a failure of these components.

The generic PTC heating module usually has a defined working point and is designed for the maximum output operation. The reason for this is that the demanded output curve of the PTC heating module is to be covered as completely as possible. Because of this, the further components are also designed correspondingly. However, the PTC heating module is far more frequently operated in a part output mode, which is not taken into account when designing the conventional PTC heating module. For this reason, the output of the PTC heating module in the part output mode is curtailed, which can result in an increased loading of the further components. In particular, the peripheral conditions—such as for example weather conditions in the areas of application of the PTC heating module—are not taken into account in the conventional PTC heating modules.

### SUMMARY

The object of the invention therefore is to state for a PTC heating module of the generic type an improved or at least alternative embodiment, with which the described disadvantages are overcome. In particular, the maximum current during the initial heating of the PTC heating module and the current peaks during the operation of the PTC heating module are to be reduced. Furthermore, the PTC heating module should also be optimally designed for the part output operation with different part outputs and for different voltages and for different peripheral conditions. The object of the invention also is to provide a corresponding method for controlling the PTC heating module.

According to the invention, these objects are solved through the subject of the independent claims. Advantageous embodiments are subject of the dependent claims.

A PTC heating module is provided for a battery-operated motor vehicle. Here, the PTC heating module comprises two electrically conductive electrodes and multiple PTC elements. The PTC elements are arranged in a height direction of the PTC module between the two electrodes and spaced apart from one another in a longitudinal direction of the PTC heating module. Here, the two electrodes are electrically conductively connected to the PTC heating elements. According to the invention, at least one of the electrodes is subdivided into at least two electrode tracks. The respective electrode tracks are electrically isolated from one another and are each electrically conductively connected to all PTC elements of the PTC heating module.

During the operation of the PTC heating module, the voltage can be applied in the respective subdivided electrode to one of the respective electrode tracks or to some of the respective electrode tracks or to all electrode tracks. Between the one electrode and the electrode tracks of the other electrode incorporated in the power circuit, or between the electrode tracks of the two electrodes incorporated in the power circuit a current is generated. The length of a current path of the current and the energized area of the electrodes in the respective PTC element can be adapted depending on the circuit diagram. Here, the current path is determined by the way in which the generated current flows through the respective PTC element with respect to the height direction. In the PTC heating module according to the invention the current path is thus determined by the way in which the energized electrode and/or the energized electrode tracks are orientated in the height direction relative to one another or whether and to what extent the energized electrode and/or the energized electrode tracks overlap one another in the height direction. Here it is conceivable that the generated current flows in the height direction and/or has a current angle greater 0° to the height direction. The energized area is defined by the geometrical area of the energized electrode and/or of the energized electrode tracks, through which the generated current flows in the respective PTC element.

In the PTC module according to the invention, different diagrams can be realised between the electrode and/or the electrode track(s). The number of the alternative circuit diagrams in the PTC heating module depends on the embodiment of its electrode. However, at least two circuit diagrams different from one another can always be realised. Depending on the circuit diagram of the electrode and/or the electrode tracks with one another, the length of the current path and the energized area in the respective PTC elements are changed. Because of this, the resistance and the capacitance of the respective PTC elements can be changed in the PTC heating module. Accordingly, the generated current and the generated output at the specified voltage can be adapted and in particular reduced. The generated current and because of this the generated output are each distinct depending on the circuit diagram so that in the PTC heating module, besides a maximum output operation, a part output operation with at least one part output different from the maximum output can also be realised.

In the PTC heating module according to the invention, the resistance and the capacitance of the PTC elements can be changed. By way of this, the generated current and the generated output in the PTC heating module can be adapted and in particular reduced. By way of this, the current peaks during the initial heating of the PTC heating module and during the operation of the PTC heating module can be reduced. Accordingly, the loading of the further electronic or electrical components caused by this can be minimised. Furthermore, the PTC heating element can be optimally designed for the part output operation with different part outputs and for different voltages and for different peripheral conditions without the physical reconstruction of the PTC heating module.

Advantageously it can be provided that the respective electrode tracks of the respective subdivided electrode are parallel to one another in the longitudinal direction and spaced apart from one another in the width direction of the PTC heating module. The electrode tracks of the respective subdivided electrode have a width in the width direction that is identical or different from one another.

Advantageously it can be provided that the one electrode and the other electrode overlap one another in regions or completely.

Advantageously it can be provided that the one electrode is subdivided into the at least two electrode tracks and the other electrode is not subdivided. The electrode that is not subdivided is only located opposite one of the electrode tracks or only some of the electrode tracks or all electrode tracks of the subdivided electrode.

Alternatively it can be provided that the two electrodes are each subdivided into the two electrode tracks. Here, the respective electrode track of the one electrode lies opposite one of the electrode tracks or some of the electrode tracks of the other electrode.

Alternatively it can be provided that the one electrode and the other electrode are each subdivided into the at least two electrode tracks. Here, the number of the electrode tracks in the two electrodes is identical in each case and the respective electrode tracks of the two electrodes each lie in pairs opposite one another in the height direction of the PTC module.

The invention also relates to a method for controlling the PTC heating module described above. In the method a voltage is applied to the electrodes of the PTC heating module and a current flows in the PTC heating element from the one electrode to the other electrode via a current path. Here, the voltage is applied in the respective subdivided electrode to one of the respective electrode tracks or to some of the respective electrode tracks or to all electrode tracks. Because of this, a length of the current path in the respective PTC elements and an energized area of the electrodes in the respective PTC elements can be adapted. Accordingly, the resistance and the capacitance of the respective PTC element can be adapted.

Advantageously, the voltage in a maximum output mode of the PTC heating module can be applied to the respective electrode tracks of the respective subdivided electrode so that the current and the output become maximal. Advantageously, in a part output mode of the PTC heating module, the voltage can be applied to the respective electrode tracks of the subdivided electrode so that the current becomes smaller than in the maximum output mode and the output smaller than in the maximum output mode. Advantageously, the PTC heating module can be operated during the initial heating in the part-output mode and after the initial heating in the maximum output mode or in the part output mode. In order to avoid repetitions, reference is made at this point to the above explanations.

Through the method according to the invention, the resistance and the capacitance of the PTC elements can be adapted. By way of this, the generated current in the respective PTC elements and the generated output in the PTC heading module can be adapted and in particular reduced. By way of this, the current peaks during the initial heating of the PTC module and during the operation of the PTC heating module can be reduced. Accordingly, the loading of the further electronic or the electrical components caused by this can be minimised. Furthermore, the PTC heating module can be optimally operated in the method according to the invention in the part output mode with different part outputs and with different voltages and with different peripheral conditions.

Further important features and advantages of the invention are obtained from the subclaims, from the drawings and from the associated figure description by way of the drawings.

It is to be understood that the features mentioned above and still to be explained in the following cannot only be used in the respective combinations stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 a lateral view of a PTC module according to the invention in a first embodiment with drawn section planes A-A and B-B;

FIGS. 2 and 3 Sectional views of the PTC heating module according to the invention in the first embodiment in the section planes A-A and B-B;

FIG. 4 to 6 Sectional views of the PTC heating modules according to the invention in the first embodiment with different circuit diagrams;

FIG. 7 to 11 Sectional views of the PTC heating module according to the invention in a second embodiment with different circuit diagrams;

FIG. 12 A sectional view of the PTC heating module according to the invention in a third embodiment with one of the possible circuit diagrams.

### DETAILED DESCRIPTION

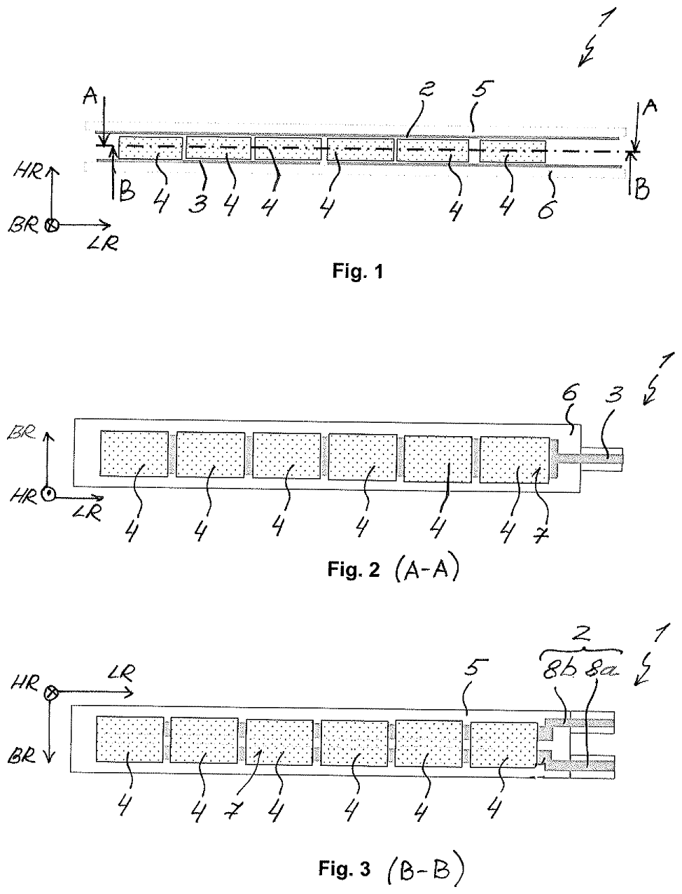

FIG. 1 shows a lateral view of a PTC heating module 1 according to the invention for a battery-operated motor vehicle in a first embodiment. FIG. 2 and FIG. 3 show sectional views of the PTC heating module 1 in the section planes A-A and B-B, which are shown in FIG. 1 Here, the PTC heating module 1 extends in a longitudinal direction LR, in a height direction HR and in a width direction BR, which are perpendicular to one another. Here, the PTC heating module 1 comprises two electrically conductive electrodes 2 and 3 and multiple PTC elements 4. The PTC elements 4 are arranged in a height direction HR between the two electrodes 2 and 3 and spaced apart from one another in a longitudinal direction LR. The two electrodes 2 and 3 extend transversely to the height direction HR and are oriented in the longitudinal direction LR. Here, the electrodes 2 and 3 are electrically conductively connected to the PTC elements 4 via an electrically conductive coating 7. In addition, two electrically isolating plates 5 and 6 of ceramic are arranged on the electrodes 2 and 3, which lie against the two electrodes 2 and 3 facing away from the PTC elements 4.

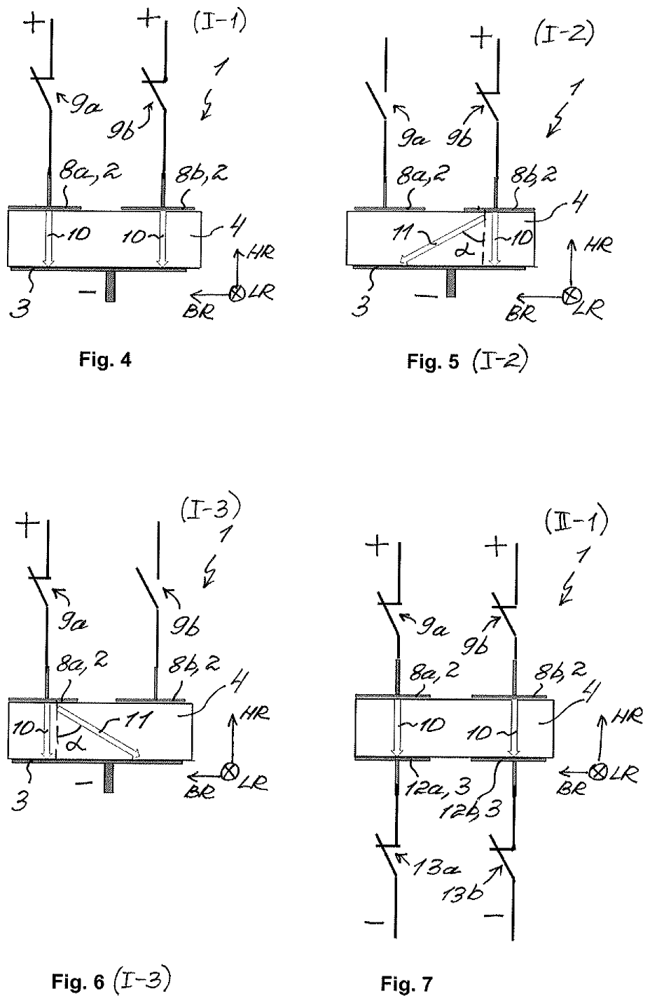

Making reference to FIG. 2 and FIG. 3, the electrode 2 is subdivided into two electrode tracks 8a and 8b. The electrode tracks 8a and 8b are oriented parallel to one another in the longitudinal direction LR. In the width direction BR, the two electrode tracks 8a and 8b are spaced apart from one another and because of this electrically isolated from one another or electrically separated from one another. A voltage can be applied to the PTC elements 4 via the respective electrode track 8a or 8b regardless of the other electrode track 8b or 8a. Thus, with the applied voltage the electrode track 8a or 8b represents an outer conductor—in FIG. 4-13 marked with “+”. The electrode 3 is not subdivided and represents a neutral conductor—in FIG. 4-13 marked with “−”.

FIG. 4 to FIG. 6 show sectional views of the PTC heating module 1 in the first embodiment transversely to the longitudinal direction LR. In FIG. 4 to FIG. 6, a total of three possible circuit diagrams I-1, I-2 and I-3 on the respective PTC element 4 are shown. It is to be understood that the other PTC elements 4 which are not shown, are connected in the same way. In the three shown circuit diagrams, I-1, I-2 and I-3, the electrodes 2 and 3 are interconnected differently. In order to realise the different circuit diagrams, I-1, I-2 and I-3 a switch 9a and 9b respectively is connected upstream of the electrode track 8a and 8b respectively. Because of this, the voltage can be independently applied to the electrode tracks 8a and 8b.

FIG. 4 now shows a first circuit diagram I-1 of the electrode 2 with the electrode 3. Here the voltage (for example 800V) is applied to the two electrode tracks 8a and 8b. For this purpose, the two switches 9a and 9b are appropriately closed. Through the applied voltage a current is generated in the PTC element 4, which then flows through the PTC element 4 via a current path 10, as indicated by arrows in FIG. 4. It is to be understood that the current path 10 merely illustrates a general direction of the current. The energized electrode tracks 8a and 8b and the energized electrode 3 overlap one another completely in the height direction HR, so that the current flows in height direction HR or at a current angle a equal to 0° to the height direction HR. The length of the current path 10 is minimal. The energized area of the electrodes 2 and 3 is maximal.

FIG. 5 and FIG. 6 show a second circuit diagram I-2 and a third circuit diagram I-3 of the electrode 2 with the electrode 3. The two circuit diagrams I-2 and I-3 are identical in their effect. In FIG. 5 and FIG. 6 respectively, the voltage (for example 800V) is applied to the electrode track 8b and 8a respectively and the other electrode track 8a and 8b is not connected. To this end, the switch 9b and 9a respectively is appropriately closed and the switch 9a and 9b opened. The energized electrodes 8b and 8a respectively and the energized electrode 3 overlap one another in the height direction HR only in regions, so that the generated current also flows through a current path 11 with a maximum length. The current paths 10 and 11 are indicated by arrows in FIG. 5 and FIG. 6. There, the current path 11 is oriented at an angle a to the height direction HR that can be maximally achieved. However it is to be understood that the current paths 10 and 11 merely illustrate a general direction of the current. In addition, the energized area of the electrodes 2 and 3 in the second circuit diagram I-2 and in the third circuit diagram I-3 is smaller than in the first circuit diagram I-1.

The resistance of the PTC element 4 is higher with the circuit diagrams I-2 and I-3 than with the circuit diagram I-1. The capacitance of the PTC element 4 by contrast is smaller. Because of this, the generated current and the generated output with the circuit diagrams I-2 and I-3 are also smaller than with the circuit diagram I-1. Accordingly, a maximum output operation can be realised with the circuit diagram I-1 and a part output operation with the circuit diagram I-2 and I-3 of the PTC heating module 1. When during the initial heating of the PTC heating module 1 the circuit diagram I-2 or I-3 is used, the generated current and because of this the loads on the further electronic or electrical components are reduced. Current peaks with the circuit diagrams I-2 or I-3 can also be reduced during the operation of the PTC heating module 1.

FIG. 7 to FIG. 11 show sectional views of the PTC heating module 1 according to the invention in a second embodiment transversely to the longitudinal direction LR. In the second embodiment of the PTC heating module 1 the electrode 2 is subdivided into the electrode tracks 8a and 8b. The electrode 3 is subdivided into two further electrode tracks 12a and 12b. In FIG. 7 to FIG. 11, the electrode tracks 8a and 8b are now differently connected to the electrode tracks 12a and 12b. Because of this, altogether five circuit diagrams II-1, II-2, II-3, II-4, and II-5 that are different from one another can be realised. In order to realise the circuit diagrams II-1, II-2, II-3, II-4, and II-5, the switch 9a and 9b respectively is connected in each case upstream of the respective track 8a and 8b respectively and a switch 13a and 13b each is connected downstream of the respective electrode track 12a and 12b respectively.

FIG. 7 now shows a first circuit diagram II-1 of the electrode 2 with the electrode 3. Here, the voltage (for example 800V) is applied to the two electrode tracks 8a and 8b and the two electrode tracks 12a and 12b are switched on. For this purpose, the switches 9a, 9b and 13a, 13b, are appropriately closed. Through the applied voltage, current is generated in the PTC element 4 which then flows through the PTC element 4 via the current path 10 with the minimum length, as indicated by arrows in FIG. 7. However it is to be understood that the current path 10 merely illustrates a general direction of the current. Here, the energized area of the electrodes 2 and 3 is maximal. In its effect, the first circuit diagram II-1 shown here corresponds to the first circuit diagram I-1 in the PTC heating module 1 in the first embodiment.

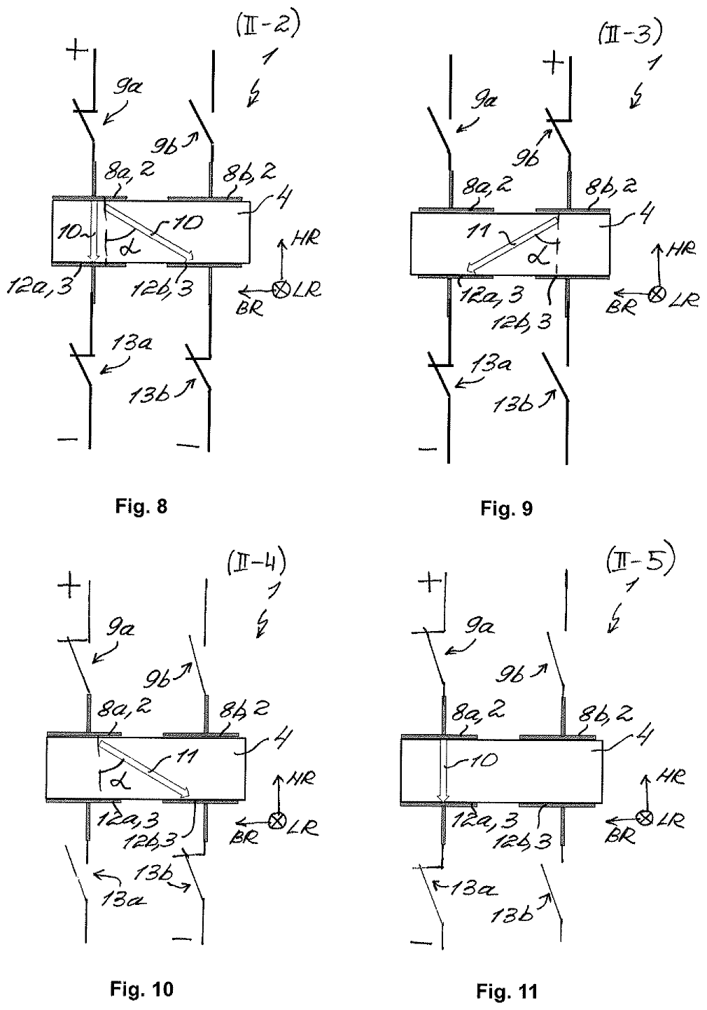

FIG. 8 shows a second circuit diagram II-2 of the electrode 2 with the electrode 3. In FIG. 8, the voltage (for example 800V) is applied to the electrode track 8a and the electrode tracks 12a and 12b are switched on. For this purpose, the switches 9a and 13a, 13b are appropriately closed and the switch 9b opened. The energized electrode track 8a and the energized electrode tracks 13a and 13b overlap one another in the height direction HR only in regions, so that the generated current flows through the current path 10 with a minimal length and through the current path 11 with a maximal length. It is to be understood that the current paths 10 and 11 merely illustrate a general direction of the current. The current paths 10 and 11 are indicated by arrows in FIG. 7. Here, the energized area of the electrodes 2 and 3 is smaller than in the first circuit diagram II-1.

FIG. 9 and FIG. 10 now show the third circuit diagram II-3 and the fourth circuit diagram II-4 of the electrode 2 with the electrode 3. In FIG. 8 and FIG. 9 respectively, the voltage (for example 800V) is only applied to the electrode track 8b and 8a respectively and only the electrode track 12a and 12b respectively is switched on. For this purpose, the switches 9b and 13a and 9a and 13b respectively are appropriately closed and the switches 9a and 13b and 9b and 13a respectively opened. The energized electrode track 8b and 8a respectively and the energized electrode track 12a and 12b respectively do not overlap one another in the height direction HR so that the generated current only flows through the current path 11 with a maximal length. The energized area of the electrodes 2 and 3 is minimal here.

FIG. 11 now shows the fifth circuit diagram II-5 of the electrode 2 with the electrode 3. In FIG. 11, the voltage (for example 800V) is only applied to the electrode track 8a and only the electrode track 12a is switched on. For this purpose, the switches 9a and 13a are appropriately closed and the switches 9b and 13b opened. The energized electrode track 8a and the energized electrode track 12a completely overlap one another in the height direction HR, so that the generated current flows through the current path 10 with the minimal length, as indicated by arrows in FIG. 8. The energized area of the electrodes 2 and 3 is also minimal here.

In the circuit diagrams I-1 to I-5, the PTC heating module 1, because of the different current paths and the different energized area, is operated at the different outputs. Here, the circuit diagram II-1 realises the maximum output operation and the circuit diagrams II-2 to II-5 realise the part output operation with three different part outputs. When during the initial heating of the PTC heating module 1 one of the circuit diagrams II-2 to II-5 is used, the generated current is reduced compared with the maximum output operation. Even during the operation of the PTC heating module 1, current peaks with the circuit diagrams II-2 to II-5 can be reduced compared with the maximum output operation.

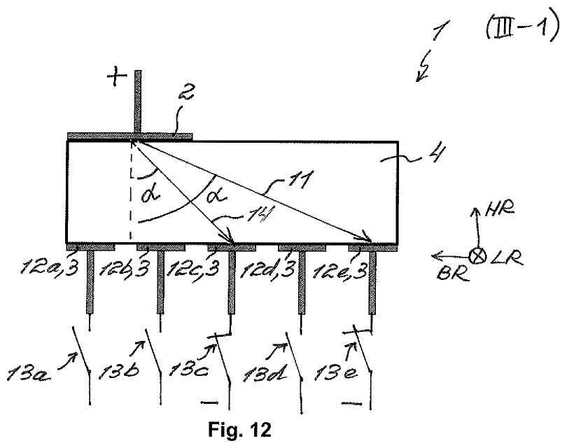

FIG. 12 shows a sectional view of the PTC heating module 1 according to the invention, in a third embodiment transversely to the longitudinal direction LR. In the third embodiment of the PTC heating module 1, the electrode 2 is not subdivided and the electrode 3 is subdivided into five electrode tracks 12a-12e. The electrode tracks 12a-12e can be switched on or switched off through the switches 13a-13e connected downstream. In the circuit diagram III-1, the respective PTC element 4 is flowed through along the flow path 11 with the maximum length and along a current path 14. The current paths 11 and 14 are oriented at the current angle a to the height direction HR. The current path 14 has a length which is between the minimum length of the current path 10 and the maximum length of the current path 11. However, it is to be understood that the current paths 11 and 14 merely illustrate a general direction of the current. With the circuit diagram III-1, the part output operation of the PTC heating module 1 is realised. It is to be understood that further circuit diagrams for realising further part output operations and the maximum output operation are conceivable here.

1. A PTC heating module for a battery-operated motor vehicle, the PTC heating module comprising:
a first and a second electrode configured to be electrically conductive; and
a plurality of PTC elements,
wherein the plurality of PTC elements are arranged in a height direction of the PTC heating module between the first and second electrodes, the plurality of PTC elements are spaced apart from one another in a longitudinal direction of the PTC heating module,
wherein the first and second electrodes are connected to the plurality of PTC elements, and
wherein
at least one of the first and second electrodes is subdivided into at least two electrode tracks, wherein the respective electrode tracks are electrically isolated from one another and are each connected to the plurality of PTC elements.

2. The PTC heating module according to claim 1, wherein
the at least two electrode tracks are disposed parallel to one another in the longitudinal direction and spaced apart from one another in a width direction of the PTC heating module.

3. The PTC heating module according to claim 1, wherein
the first electrode and the second electrode overlap one another in regions or completely.

4. The PTC heating module according to claim 1, wherein
one of the first and second electrodes is subdivided into the at least two electrode tracks and the other one of the first and second electrodes is not subdivided.

5. The PTC heating module according to claim 1, wherein
the first and second electrodes are each subdivided into the at least two electrode tracks, and
the respective electrodes tracks of one of the first and second electrodes are located opposite one of the respective electrode tracks or some of the respective electrode tracks of the other one of the first and second electrodes.

6. The PTC heating module according to claim 1, wherein
the first and second electrodes are each subdivided into the at least two electrode tracks, and wherein a number of the electrode tracks in the first and second electrodes is the same and
wherein the respective electrode tracks of the first and second electrodes are located opposite one another in pairs in the height direction of the PTC heating module.

7. A method for controlling the PTC heating module according to claim 1, the method comprising:
applying a voltage to the first and second electrodes, and causing a current to flow in the plurality of PTC elements from one of the first and second electrodes to the other one of the first and second electrodes via a current path, and
wherein the voltage in the at least one of the first and second electrodes that is subdivided is applied to one of the at least two electrode tracks, or to some of the at least two electrode tracks or to all of the at least two electrode tracks, and a resistance and a capacitance of the plurality of PTC elements are thereby adapted.

8. The method according to claim 7, wherein
in a maximum output mode of the PTC heating module, the voltage is applied to the at least two electrode tracks so that the current and the output become maximal.

9. The method according to claim 8, wherein
in a part output mode of the PTC heating module, the voltage is applied to the at least two electrode tracks so that the current and the output becomes smaller than in the maximum output mode.

10. The method according to claim 9, wherein
during an initial heating, the PTC heating module is operated in the part output mode, and after the initial heating, the PTC heating module is operated in the maximum output mode or in the part output mode.

11. The PTC heating module according to claim 2, wherein each of the at least two electrode tracks include a width that is identical to one another.

12. The PTC heating module according to claim 2, wherein each of the at least two electrode tracks include a width that is different from one another.

13. The PTC heating module according to claim 4, wherein the other one of the first and second electrodes that is not subdivided is disposed opposite only one of the at least two electrode tracks.

14. The PTC heating module according to claim 4, wherein the other one of the first and second electrodes that is not subdivided is disposed opposite some of the at least two electrode tracks.

15. The PTC heating module according to claim 4, wherein the other one of the first and second electrodes that is not subdivided is disposed opposite all the at least two electrode tracks.

16. A PTC heating module for a battery-operated motor vehicle, comprising:
a first electrode;
a second electrode spaced apart from the first electrode defining a space; and
a plurality of PTC elements disposed within the space,
wherein at least one of the first and second electrodes is subdivided into at least two electrode tracks.

17. The PTC heating module according to claim 16, wherein the respective electrode tracks are electrically isolated from one another.

18. The PTC heating module according to claim 16, wherein the respective electrode tracks are connected to the plurality of PTC elements.

19. The PTC heating module according to claim 16, wherein the at least two electrode tracks are disposed parallel to and spaced apart from one another.

20. The PTC heating module according to claim 16, wherein the first electrode and the second electrode overlap one another.
